(19) United States
(12) Patent Application Publication
(10) Pub. No.: US 2021/0121921 A1
(43) Pub. Date: Apr. 29, 2021

(54) INDIVIDUAL IDENTIFICATION OF A BAG AND ASSOCIATED TRANSPORT METHOD

(71) Applicant: LEMO MASCHINENBAU GMBH, Niederkasel-Mondorf (DE)

(72) Inventor: Berndt SCHLARP, Niederkassel (DE)

(21) Appl. No.: 17/056,682

(22) PCT Filed: May 6, 2019
(86) PCT No.: PCT/EP2019/061575

§ 371 Date: Jan. 3, 2021

(30) Foreign Application Priority Data
Jul. 16, 2018 (DE) 10 2018 117 158.7

(51) Int. Cl. B07C 3/12; B07C 3/18; G06K 19/06

(52) U.S. Cl. CPC B07C 3/12; G06K 19/06037; B07C 3/18

(57) ABSTRACT

A method for sending an item (2) in an outer packaging (3) from a sender (1) to a recipient (14) over a transport route (12, 13), wherein the outer packaging (3) has an identifier (4) containing data identifying at least the recipient (14), characterized in that an outer packaging (3) provided with an individual identifier (4) is used, wherein the identifier (4) is captured by a data processing installation (9) and the identifier (4) is assigned the data identifying at least the recipient (14) by the data processing installation (9) and these data are provided by the sender (1) in particular by means of an input device (8) connected to the data processing installation (9).

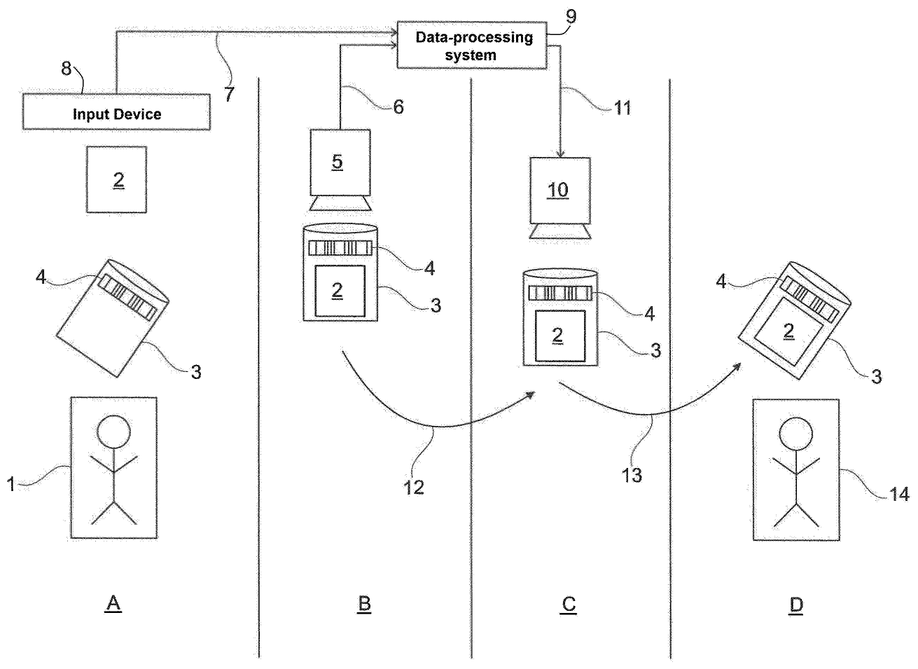

The invention relates to a method of sending an object in an outer packaging from a sender via a transport route to a recipient, the outer packaging having an identifier with at least data identifying the recipient, according to the features of the preamble of claim 1.

Nowadays, many items, in particular via online mail order, are shipped by a sender in an outer packaging for transport to the recipient. The outer packaging is usually a cardboard box or mailer made of plastic, for example. If the item to be sent has been placed in the outer packaging and it has been closed, a label, often a self-adhesive label, is printed in a known manner with data that at least identify the recipient, in particular its address. In addition to these human-readable identifications (standard copy), machine-readable identifications, for example bar codes, can also be printed on the label. With this data, which can be read by people and, if necessary, also by machines, the outer packaging with the item contained therein is shipped along the transport route to the recipient.

In this known method, it is necessary not only to provide the outer packaging, but also to provide a label, preferably a self-adhesive label for simpler handling, this blank label with the data that identify the recipient (for example a recipient address that can be read by a person). After the printing process, for which a corresponding printer must be kept available, it is necessary to secure the printed label to the outer packaging, in particular to glue it there. This not only increases the workload, but also the cost of materials. In addition, it is disadvantageous that, for environmental reasons, it is difficult to dispose of the outer packaging with the affixed label that contains soft adhesive and printing inks.

In these known methods, the identifier with at least data identifying the recipient, possibly also additional data, is generated from these data so that, conversely, the recipient's data derived from the identifier on the label, be it readable in fair copy or machine-readable identifying data, can be read out or recorded directly by a person. It is therefore an identifier that is only generated from the data that identify the recipient, for example his address.

Such a method of distributing mail items is known from EP 1,257,954 [US 2003/0004893].

The object of the invention is to simplify a method of sending an item in an outer packaging, in particular for a mail-order business that has to send a very large number of items every day.

This object is attained by the features of claim 1.

According to the invention, outer packagings provided with respective unique identifiers are used, the identifiers being recorded by a data-processing system and including data identifying at least the recipient being held in the data-processing system and this data in particular made available via an input device connected to the data-processing system by the sender.

According to the invention, the identifier is therefore not, as is known in the prior art, generated from the data that identify the recipient, but conversely a unique identifier is used that for example has not yet been assigned any data, and only then the identifier data that identify the recipient, are added. Because the outer packaging is already provided with the unique identifier, the disadvantageous use of a label, which in the prior art has to be applied to the outer packaging, is avoided. Only after the unique identifier has been recorded by the data-processing system can the data that identify the recipient and that are provided by the sender be added to this identifier. There is thus a correlation and not a generation of a unique identifier from the data provided, as is the case in the prior art. The use of a data-processing system is therefore necessary and advantageous, because the entire transport of the outer packaging with the internal item from the sender to the recipient can be controlled and possibly tracked by reading out the unique identifier.

With the method according to the invention, the entire transport route, in particular for the professional mail-order business, but also for private individuals, can thus be significantly simplified and accelerated. In particular, the use of separate labels, in particular self-adhesive labels, and the application of a unique identifier, which according to the prior art is only generated from the data provided on the label are eliminated. This not only simplifies the handling of the outer packaging during filling with the item and the subsequent transport, but it also saves material and protects the environment.

In a further development of the invention, a plastic shipping bag is used as the outer packaging. Such a mailer made of plastic not only has the advantage that it can be quickly and easily produced in any desired size, but that it also adapts to the contours of the item that is to be shipped with it. In addition, such a mailing bag can be used several times and is significantly less susceptible to environmental influences (in particular moisture, cleats and the like) than outer packaging made from cardboard. At the same time, an outer packaging made of a cardboard material can also be used for the method according to the invention.

In a further development of the invention the identifier is formed by the outer packaging. While it is conceivable when using outer packaging made of cardboard material to print the unique identifier directly onto the surface when the outer packaging is manufactured, for example (this identifier does not yet contain any data, as it is not yet known which data it should contain, which identify the recipient), it is especially advantageous when using a mailer made of plastic if the unique identifier is incorporated into the surface of the plastic of the mailer. This incorporation can take place, for example, by a laser, but also by a chemical process (such as etching).

In a further development of the invention the identifier is read several times on the transport route. This makes it possible to record the identifier that the outer packaging had immediately after its manufacture and that did not contain any data at this point in time (since this was only assigned to this unique identifier later) in order to control the transport route (for example from one logistics center to the next, etc.) and, if necessary, trace the transport route.

In a further development of the invention the outer packaging, in particular the plastic shipping bag, are provided as a roll, especially when using mailing bags

With plastic it is conceivable to produce a large number of unique mailing bags that are still connected to one another and to wind them up on a roll. The term “endless roll” is therefore to be understood as meaning a roll that forms a predetermined large number of mailing bags arranged one behind the other on the roll.

From such a roll, mailing bags are removed uniquely from the roll at the sender in order to put the item to be sent in it and then to correlate the data that identifies the recipient to the unique identifier that each mailing bag carries.

In a special development of the invention, each of the outer packagings (mailers) of the endless roll is provided with its own unique identifier, the identifier of one of the outer packagings (mailers) differing from the identifier of the other outer packagings (mailers). To stay with the example of mailers wrapped on a roll, this means that a certain number of mailers are wound on the endless roll and are initially connected to one another, for example, are separably connected to one another by a perforation line. Each unique mailer has its own unique identifier, with as many unique identifiers being present on the entire endless roll as there are mailers on the endless roll. As a result, the sender is provided with a mailing bag with its own unique identifier for each unique item being shipped, and it is possible to correlate the data that identify the recipient to this own unique identifier in order to then assign the outer packaging to the appropriate transport route.

The above, insofar as it relates to a shipping bag as outer packaging, also applies in the same way to other types of outer packaging, for example those made of cardboard material. Outer packaging made from cardboard material can, for example, be stacked, with a stack of outer packagings containing several of these outer packaging, each outer packaging, just as with the shipping bags, carrying its own unique identifier. This can be done, for example, after each outer packaging has been produced from cardboard material, by printing a unique identifier on it. However, as already stated, data are only assigned to this identifier when the outer packaging is filled with the item and the data of at least the recipient, and possibly also further data, are known.

In a further development of the invention, a machine-readable code is used as the unique identifier. In a particularly preferred manner, a QR code is used as the machine-readable code. This has the advantage that handling of the outer packaging on the transport route can take place very quickly and, above all, can be at least partially automated. In addition, depending on the application, there could be the advantage that the outer packaging that has arrived at the recipient cannot be recognized directly by a person in order to ensure that the outer packaging is safely transferred from the deliverer to the recipient.

The method described above is explained and described in greater detail below with the aid of a system shown in the figure.

A sender 1 intends to place an item 2 in an outer packaging 3 and to send it therein. For this purpose, the sender 1 uses an outer packaging 3 with a unique identifier 4 that this outer packaging 3 already carries. This unique identifier 4 has not yet been provided with any further data, in particular data relating to a possible recipient or further details of the shipment, since these are not yet known at this time.

This is in station A.

Station B has a reader 5 that has a data line 6. An input device 8 with which the sender 1 can provide data that characterize the shipment has a further data line 7. Both the reader 5 and the input device 8 are connected by their respective data lines 6 and 7 to a data-processing system 9. The input device 8 is in station A with the sender 1, and the reader 5 can be located in the station A or, as shown in the figure, can be located in another station, namely in station B.

Station A is, for example, the packaging room of an online mail-order company that holds a large number of the items 2. A plurality of outer packagings 3 each with its own, different unique identifier 4 is removed for example from an endless roll, the outer packagings 3 in this case being plastic shipping bags. Every time a unique item 2 has been placed in a respective one of the outer packagings 3 with its unique identifier 4, the data relating to this shipment, in particular the data that characterizes the recipient, are entered by the sender 1 via the input device 8 and are sent by the data line 7 to the data-processing system 9.

If a large number of outer packagings 4 are ready, they can be transferred to a logistics company in station B, for example. This logistics company uses the reader 5 to record the unique identifiers of each outer packaging 4, the respective unique identifiers 4 being transmitted to the data-processing system 9 via the data line 6. In the data-processing system 9, the data that has been entered via the input device 8 and transmitted to the data-processing system 9 is correlated with the respective recorded unique identifiers 4.

After correlating the data identifying the recipient with the respective unique identifier 4 of the respective outer packaging 3, it can be transported on from the station B. This onward transport takes place, for example, to an intermediate station C, for example another logistics center. A reader 10 there is also connected to the data-processing system 9 via a further data line 11. There it is again possible to read out the unique identifier 4 for further checking of the transport route.

After further transport of the respective outer packaging 3 from the station B or via the intermediate station C has taken place, the outer packaging 3 arrives at a recipient.

The route from station B to station C is transport route 12 and the further transport from station C to receiver D is transport route 13. There can be several intermediate stations C. For the sake of completeness, the recipient is shown at 14. He receives his unique outer packaging 3 with the respective unique identifier 4, and, for example, a delivery person has a reader for this unique identifier 4 available and the reader already contains the data that identifies the recipient 14 or it is received from the data-processing system 9 for example wired or wireless.

The shipping data provided via the input device 8 are assigned in practice to the respective unique identifier of the shipping bag, for example by reading the identifier 4 and the order number of the shipment that can also be a machine-readable code.

It should also be mentioned that the parcel not only contains the unique identifier (e.g. a QR code), but that the recipient's address can also be printed in standard copy, for example. Since the linking of the unique ID with the order and the recipient takes place only after the transfer, this could be a further step (especially printing). Then one could optionally save the unique ID and apply all data only after the filling process.

For returns, the procedure is as described, only that the original recipient automatically becomes the sender, supplemented by the delivery confirmation. The data are all available due to the connection in A.

In general, it should be added that the machine-readable identification can contain information just as individualized as a virtual token and can be billed automatically between the sender and the logistics company.

### LIST OF REFERENCE SYMBOLS

1 Sender
2 Subject
3 Outer packaging
4 Identifier
5 Reader
6 Data line
7 Data line
8. Input device
9 Data-processing system
10 Reader
11 Data line
12 Transport route
13 Transport route
14 Recipient

1. A method of shipping an item in an outer packaging from a sender via a transport route to a recipient, the method comprising the step of:
manufacturing the outer packaging with a unique package identifier;
the sender providing the packaging with a recipient identifier holding data identifying at least the recipient and placing the item to be shipped into the outer packaging;
the sender recording the package and recipient identifiers by an input device to a data-processing system; and
the data-processing system correlating data identifying the recipient from the recipient identifier with data from the package identifier of the respective outer packaging.

2. The method of shipping an item according to claim 1, wherein a plastic shipping bag is used as the outer packaging.

3. The method of shipping an item according to claim 1, wherein the identifier is formed by the outer packaging.

4. The method of shipping an item according to claim 1, wherein the identifier is read several times along the transport route.

5. A method of shipping an item according to claim 2, wherein the plastic shipping bags, are provided on an endless roll.

6. The method of shipping an item according to claim 5, wherein the outer packagings of the endless roll are each provided with their own unique identifiers, the identifier of one outer packaging being different from the identifiers of the other outer packagings.

7. The method of shipping an item according to claim 1, wherein a machine-readable code is used as the unique package identifier.

8. The method of shipping an item according to claim 7, wherein a QR code is used as a machine-readable package code.
